(19) United States
(12) Patent Application Publication
(10) Pub. No.: US 2006/0031321 A1
(43) Pub. Date: Feb. 9, 2006

(54) Electronic mail distribution network with simple user-friendly interactive implementation enabling a user at a receiving display terminal to turn off spam

(75) Inventors: Ira R. Forman, Austin, TX (US); Nadeem Malik, Austin, TX (US)

Correspondence Address: Mark E. McBurney;International Business Machines Corporation, Intellectual Property Law Department, 11400 Burnet Road, Austin, TX, 78758, US

(73) Assignee: International Business Machines Corporation, Armonk, NY (US)

(21) Appl. No.: 10/870,538

(22) Filed: Jun. 17, 2004

(51) Int. Cl. G06F 15/16

(52) U.S. Cl. 709/206

(57) ABSTRACT

A user is provided with a simple inexpensive and interactively intuitive implementation of selectively turning spam off his receiving E-mail terminal. An E-mail distribution system for eliminating nuisance electronic mail, e.g. spam, from mail sent to said receiving terminals from sending locations remote from such terminals. Respective conventional addresses are assigned to each of the receiving terminals and there is a conventional implementation for addressing mail respectively to each of these receiving terminals. An implementation respectively at each of the receiving terminals enables the user to modify the receiving terminal address to include the designation of a server intermediate the sending location and apparatus at the intermediate server identifies and eliminates nuisance electronic mail. A routing function routes to the intermediate server, electronic mail addressed to the receiving terminal with the modified address.

### TECHNICAL FIELD

The present invention relates to computer managed communication networks, such as the World Wide Web (Web), electronic mail (E-mail) messages transmitted over such networks and, particularly, to the elimination of nuisance electronic mail, e.g. spam that intrudes into the E-mail received at receiving network display terminals.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Also, as a result of the rapid expansion of the Web, E-mail, that has been distributed for over 25 years over smaller private and specific purpose networks, has moved into distribution over the Web because of the vast distribution channels that are available.

In order to encourage this rapid expansion of the Web, there has been an emphasis on easy access both for the receivers of E-mail and other Web documents and for the providers and sources of such mail and documents. However, along with the obvious advantages of such an open system has come a set of problems resulting from an open system. A major one of such problems has been the proliferation of unsolicited spam and like nuisance electronic mail that is distributed en masse over the Web or Internet and, at the very least, clogs up the “In-boxes” of the receiving terminals.

While spam may be a nuisance to 99% of its recipients, the purveyors still consider it a cheap and effective way of reaching their target 1% or less. However, spam is more than an inconvenient nuisance. It has been estimated that there are 15 billion spam messages a day. Also, in 2003, the estimated costs to U.S. businesses for the elimination of spam has been about $10 billion. With such costs involved, it is clear that there are a great many relatively effective systems for spam elimination available to business and other organizations able to bear the costs of spam elimination. On the other hand, smaller individual consumers/users and home receiving terminals are often faced with the choices of living with the spam inconvenience, wasting valuable time with the installation, maintenance and updating of complex systems or paying the higher costs of sophisticated spam elimination systems.

### SUMMARY OF THE PRESENT INVENTION

The present invention is directed to the needs of primarily the smaller and less technology-sophisticated receiving terminal user, and provides such user with a simple, inexpensive and interactively intuitive implementation of selectively turning spam off his receiving E-mail terminal.

The invention is applicable to communication networks, such as the Web or Internet, with user access via a plurality of data processor controlled interactive receiving display terminals. It provides for an E-mail distribution system for eliminating nuisance electronic mail, e.g. spam from mail sent to said receiving terminals from sending locations remote from such terminals. The invention uses the combination of means for assigning respective addresses to each of the receiving terminals; means for addressing mail respectively to each of these receiving terminals; means enabling a user respectively at each of the receiving terminals to modify the receiving terminal address to include the designation of a server intermediate the sending location; and means at the intermediate server for identifying and eliminating nuisance electronic mail. The implementation of the invention further includes routing means for routing to the intermediate server, electronic mail addressed to the receiving terminal with the modified address.

The system is made user-friendly and intuitive by the combination of means on the receiving display terminal for prompting a user to interactively select to modify the terminal address, together with means responsive to this user selected means for inserting the domain of the intermediate server into the address of said receiving display terminal.

The intermediate server may conveniently be a hub server for identifying and eliminating spam from a plurality of said receiving display terminals. The significant advantage of this invention is that it provides a very simple and cost effective implementation for enabling all users to access a spam disposal hub server system that may be maintained and continually upgraded with the latest and most sophisticated expedients. Because the costs of this system maintenance are minimized by the sharing of a great many subscribers, each individual user has the benefit of spam elimination technology well beyond what the user could afford on an individual basis.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized view of an E-mail distribution system over an illustrative Internet or Web with the receiving terminal user-enabled spam elimination implementation;

FIG. 2 is a block diagram of a data processing system including a central processing unit and network connections via a communications adapter that is capable of implementing the receiving display computer terminal 56 (FIG. 1), on which E-mail may be received, as well as implementing the spam protection hub server 51 and any of the Internet servers 58 and 44 through 46;

FIG. 3 is an illustrative generalized view of a portion of a receiving terminal display screen showing the user prompt enabling the spam elimination process;

FIG. 4 is the view of FIG. 3 after a spam attack;

FIG. 5 is the view of FIG. 4 after the user has activated spam elimination;

FIG. 6 is an illustrative flowchart describing the setting up of the functions to receive E-mail and to enable the receiving user to initiate spam elimination; and

FIG. 7 is a flowchart of an illustrative run of the program set up according to FIG. 6.

### DETAILED DESCRIPTION OF THE PREFERRED EMBODIMENT

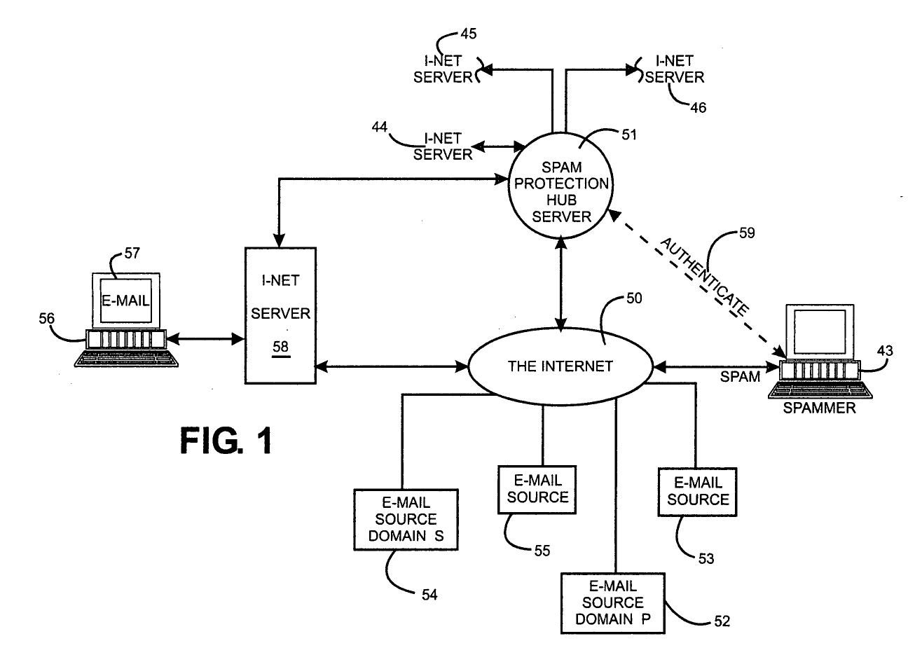

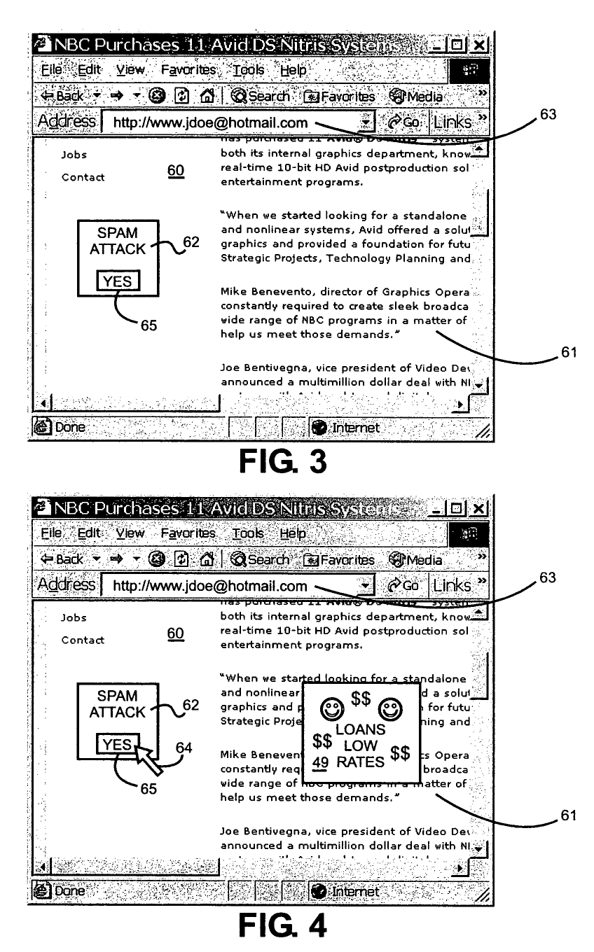

Referring to FIG. 1, there is provided a generalized electronic mail distribution system over a network, such as the Internet, showing the elements of the spam elimination system of the present invention. In the following description, it will be understood that the described elements will be triggered by the user activating the eliminate spam prompt, as will hereinafter be described in greater detail with respect to the display screen sequence of FIGS. 3 through 5. Receiving display terminal 56, FIG. 1, illustrates an E-mail receiving terminal having a display screen 57 on which received E-mail is displayed. Terminal 56 is connected into the Internet 50 through Internet server 58 and receives E-mail from a variety of sources 52 through 55. Into this simple arrangement the spammer intrudes from spammer source terminal 43, blanketing receiving terminals throughout the network, such as terminal 56, with span, as will be illustrated subsequently with respect to FIGS. 3 through 5. When this occurs, or preemptively, the user will respond to a spam eliminate prompt and the expedient of the present invention will be initiated. Then, the address of the receiving terminal will be modified, as will be described in FIGS. 3 through 5. When this occurs, the address modification will result in diversion of the incoming mail to intermediate hub server 51 that filters out spam using any of the hundreds of spam elimination techniques. The present invention is not concerned with the type of spam elimination used; that is currently a well developed and known art. The point of the present invention involves the user enabled modification of the receiving terminal address to divert to a common hub server that conventionally deals with the spam elimination, e.g. with an authentication routine 59 to and from the suspected spammer terminal 43. Note that the hub server 51 will perform the same elimination for a plurality of receiving terminals respectively connected to the hub server 51 via Internet servers 44 through 46. The user at the respective receiving terminal may exempt known E-mail sources from the spam elimination of server 51, e.g. by designating their respective domains, such as the domains of sources 52 and 54.

As set forth above, the particular spam elimination method does not have any criticality to the invention. In fact, spam elimination is a very fluid technology that has to continually change and become increasingly sophisticated in order to keep up with the spammers who are also continually striving to become more sophisticated in order to keep a step ahead of spam elimination technology. For these reasons, the service to businesses and to consumers offered by the present invention may be valuable. The E-mail user does not have to constantly update to have the latest spam filtering innovations with the attendant costs and time used. The business service provides a simple interactive display process that diverts E-mail through the intermediate hub server via address modification. The hub server provider through the financial support of his fees to his subscribers can bear the costs of the latest spam elimination technology.

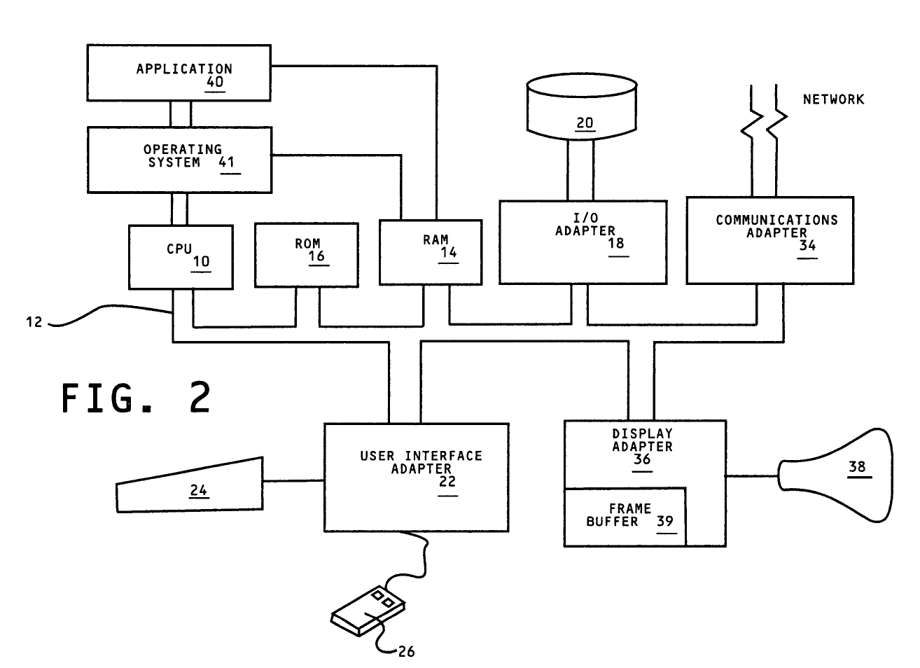

Referring to FIG. 2, a typical data processing terminal is shown that may function as a receiving display terminal 56 (FIG. 1) or the hub server 51 (FIG. 1) or any of the Internet servers 44 through 46 and 58 in the processing of the E-mail. A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 2. Operating system 41 may be one of the commercially available operating systems, such as the AIX ₆₀₀₀™ operating system available from IBM; Microsoft's Windows XP™ or Windows NT™, as well as UNIX and AIX operating systems. Application programs 40, controlled by the system, are moved into and out of the main memory, random access memory (RAM) 14. These programs include the programs of the present invention for enabling the user to modify the address so as to include an intermediate routing of E-mail through the spam protection hub server 51 and for appropriate communication between such terminals for the processing of E-mail.

A read only memory (ROM) 16 is connected to CPU 10 via bus 12 and includes the basic input/output system (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with an outside network enabling the data processing system to communicate as respectively described above through the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively receive or control E-mail messages. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38. When the data processing system of FIG. 2 is functioning as the hub server for the elimination of E-mail, then the above-described application programs 40 will include any of a wide variety of known techniques for elimination of spam.

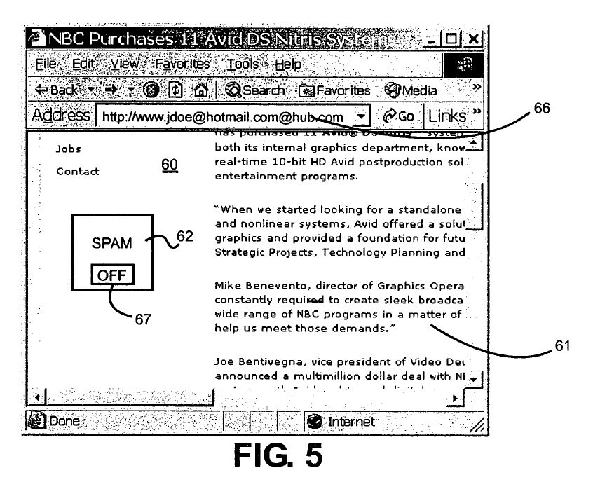

Now with respect to the sequence of FIGS. 3 through 5, there will be described a simple illustration of the spam elimination function of this invention. FIG. 3 shows part of a display screen 60 containing part of an E-mail addressed to: “jdoe@hotmail.com” 63. There is also available, a button 65 in dialog box 62 that enables the user to trigger a modification in the user's E-mail address that will route any E-mail addressed to the receiving terminal to the hub server for processing and eliminating spam from E-mail. Considering now FIG. 4, spam 49 appears. The user clicks on button 65 with cursor 64. This results in the change shown in FIG. 5 wherein the address of the receiving station is modified to read: “jdoe%hotmail.com@hub.com” 66. This change in the receiving terminal address will divert all E-mail to the central hub (“@hub.com”) where spam elimination may be done using conventional techniques. During the “on” period for span elimination, a new dialog box 62 appears with a button 67 for turning the span elimination function off when there are operating conditions where span elimination is no longer necessary.

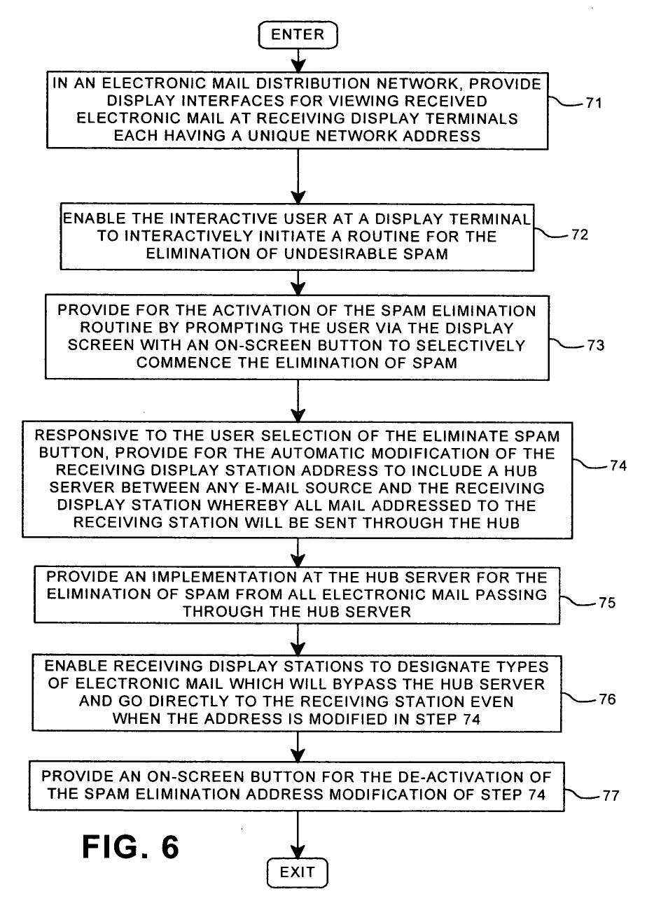

Now, with respect to FIG. 6 there will be described the programming functions that should be set up in order to practice this invention. In an electronic mail distribution network, such as the Internet, a conventional E-mail receiving system is set up with receiving display terminals for receiving and viewing E-mail. Each receiving terminal has a conventional unique E-mail address, step 71. The user at each receiving terminal is enabled to selectively and interactively initiate a routine for eliminating span, step 72. The routine of step 72 is enabled through on-screen user prompt on the receiving terminal, e.g. a click-on button is provided, step 73. A set up is then provided responsive to the user selection of the span elimination button of step 73 to automatically modify the receiving station address to include a hub server on the routing path of E-mail to the receiving station that is between the source of E-mail and the receiving station or terminal. As a result of such an address modification, all E-mail addressed to the particular receiving station will be passed through this central span clearing hub server, step 74. This hub server is a central or global server, i.e. a great many receiving terminals may obtain access to the span clearing services of the central server. This permits the server to use sophisticated, complex and even high maintenance span clearing routines, step 75, that would be too complex and costly for the individual consumer, e.g. home terminal user. It should again be emphasized that this invention is not bound to any particular spam clearing routines out of the hundreds of available routines to be practiced by the hub server. This invention provides an ease of use selection of spam elimination involving the automatic modification of the receiving terminal address to divert the E-mail routing through the central span clearing hub server.

In accordance to a particular aspect of this invention, the users may be provided with interactive display means for selecting E-mail sources known to the receiving user to be exempt from any spam clearing, e.g. the hub server may be by-passed, step 76. This may be done simply at the receiving terminal by not using the modified address when communicating with such known sources. Alternatively, provision may be made for the hub server filtering and then passing such known source E-mail directly to the receiving terminal without span authentication.

Finally, step 77, an on-screen button may be provided that enables the user to deactivate the span elimination routing by clicking off to remove the E-mail address modification and return to the original E-mail address of the receiving station.

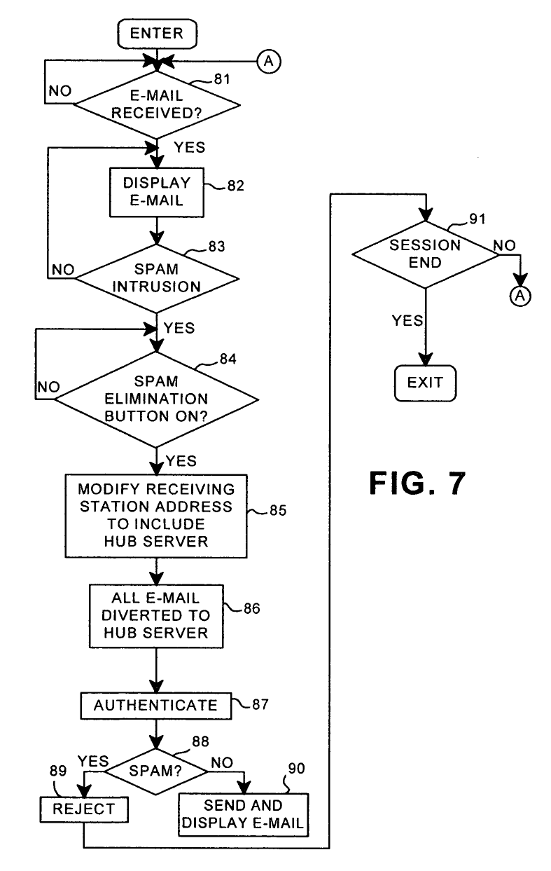

Now, with reference to the flowchart of FIG. 7 a simplified illustrative run of the process set up in FIG. 6 will be described. The E-mail is awaited at the receiving station or terminal. When Yes, step 81, an E-mail is received, it is routinely displayed and processed, step 82. A determination may then continuously be made as to whether there has been a span intrusion, step 83. This may be as intrusive as an on-screen overlaid display of the span or it may just be an in-box overload of spam. If Yes, there has been a span intrusion, a determination is made, step 84, as to whether the user has pushed the on-screen spam elimination button. If Yes, then, step 85, the receiving station address is automatically modified to define a route that will include the hub server. Subject to the exceptions described above with respect to FIG. 6, step 76, all subsequent E-mail will be diverted to the hub server, step 86. The E-mail will be subjected to hub server spam elimination processing, such as authentication routines, step 87. Thus, a determination is consequently made as to whether the E-mail is spam, step 88. If Yes, the E-mail is rejected, step 89. If No, the E-mail is then sent through to the receiving terminal where it is displayed, step 90. At this point, a determination may conveniently be made as to whether the session is over, step 91. If Yes, the session is exited. If No, the session is returned via branch A to step 81.

It should be noted that the programs covered by the present invention may be stored outside of the present computer systems until they are required. The program instructions may be stored in another readable medium, e.g. in disk drives associated with the receiving terminals or the hub servers. The program instructions may be in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a communication network with user access via a plurality of data processor controlled interactive receiving display terminals, an electronic mail distribution system for eliminating nuisance electronic mail from mail sent to said receiving terminals from sending locations remote from said terminals comprising:
means for assigning respective addresses to each of said receiving terminals;
means for addressing mail respectively to each of said receiving terminals;
means enabling a user respectively at each of said receiving terminals to modify said receiving terminal address to include the designation of a server intermediate said sending location and said receiving terminal; and
means at said intermediate server for identifying and eliminating nuisance electronic mail.

2. The electronic mail distribution system of claim 1 further including routing means for routing to said intermediate server, electronic mail addressed to the receiving terminal having said modified address.

3. The electronic mail distribution system of claim 2 wherein said nuisance electronic mail is spam.

4. The electronic mail distribution system of claim 3 wherein said means for enabling a respective user to modify said receiving terminal display address comprises:
means on said receiving display terminal for prompting a user to interactively select to modify said terminal address; and
means responsive to said user select means for inserting the domain of said intermediate server into the address of said receiving display terminal.

5. The electronic mail distribution system of claim 4 wherein said intermediate server is a hub intermediate server for identifying and eliminating spam from a plurality of said receiving display terminals.

6. The electronic mail distribution system of claim 5 wherein said means for identifying and eliminating spam includes means for authenticating the sender of electronic mail received at said intermediate server.

7. The electronic mail distribution system of claim 6 further including means enabling the user at a receiving display terminal to select types of received electronic mail that do not require authentication.

8. In a communication network with user access via a plurality of data processor controlled interactive receiving display terminals, an electronic mail distribution method for eliminating nuisance electronic mail from mail sent to said receiving terminals from sending locations remote from said terminals comprising:
assigning respective addresses to each of said receiving terminals;
addressing mail respectively to each of said receiving terminals;
enabling a user respectively at each of said receiving terminals to modify said receiving terminal address to include the designation of a server intermediate said sending location and said receiving terminal; and
identifying and eliminating nuisance electronic mail at said intermediate server.

9. The electronic mail distribution method of claim 8 further including the steps of routing to said intermediate server, electronic mail addressed to said receiving terminal having said modified address.

10. The electronic mail distribution method of claim 9 wherein said nuisance electronic mail is spam.

11. The electronic mail distribution method of claim 10 wherein said steps enabling a respective user to modify said receiving terminal display address comprises:
prompting a user on said receiving display terminal to interactively select to modify said terminal address; and
responsive to said user selection inserting the domain of said intermediate server into the address of said receiving display terminal.

12. The electronic mail distribution method of claim 11 wherein said intermediate server is a hub intermediate server for identifying and eliminating spam from a plurality of said receiving display terminals.

13. The electronic mail distribution method of claim 11 wherein said step of identifying and eliminating spam includes the step of authenticating the sender of electronic mail received at said intermediate server.

14. The electronic mail distribution method of claim 13 further including enabling the user at a receiving display terminal to select types of received electronic mail that do not require authentication.

15. A computer program having code recorded on a computer readable medium for eliminating nuisance electronic mail from mail sent to said receiving terminals from remote sending locations in a communication network with user access via a plurality of data processor controlled interactive receiving display terminals, said computer program comprising:
means for assigning respective addresses to each of said receiving terminals;
means for addressing mail respectively to each of said receiving terminals;
means enabling a user respectively at each of said receiving terminals to modify said receiving terminal address to include the designation of a server intermediate said sending location and said receiving terminal; and
means at said intermediate server for identifying and eliminating nuisance electronic mail.

16. The computer program of claim 15 further including routing means for routing to said intermediate server, electronic mail addressed to said receiving terminal having said modified address.

17. The computer program of claim 16 wherein said nuisance electronic mail is spam.

18. The computer program of claim 17 wherein said means enabling a respective user to modify said receiving terminal display address comprises:
means on said receiving display terminal for prompting a user to interactively select to modify said terminal address; and
means responsive to said user selected means for inserting the domain of said intermediate server into the address of said receiving display terminal.

19. The computer program of claim 18 wherein said intermediate server is a hub intermediate server for identifying and eliminating spam from a plurality of said receiving display terminals.

20. The computer program of claim 18 wherein said means for identifying and eliminating spam includes means for authenticating the sender of electronic mail received at said intermediate server.

21. The computer program of claim 20 further including means enabling the user at a receiving display terminal to select types of received electronic mail that do not require authentication.

22. A business method offering to electronic mail consumers at receiving display terminals, each having a unique address in an electronic mail distribution network, a function for eliminating nuisance electronic mail from mail sent to said receiving terminals from sending locations comprising:
maintaining a process for identifying and eliminating nuisance electronic mail at a hub server; and
enabling a user respectively at each of said receiving display terminals to modify said receiving terminal address to include the designation of said hub server intermediate said sending location and said receiving terminal;
whereby electronic mail addressed to said receiving terminal having said modified address is routed to said intermediate hub server.

23. The method of claim 22 wherein said nuisance electronic mail is spam.

24. The method of claim 23 wherein said steps enabling a respective user to modify said receiving terminal display address comprises:
prompting a user on said receiving display terminal to interactively select to modify said terminal address; and
responsive to said user selection inserting the domain of said intermediate hub server into the address of said receiving display terminal.

25. The method of claim 24 wherein said step of identifying and eliminating spam includes the step of authenticating the sender of electronic mail received at said intermediate server.

26. The method of claim 25 further including the step of enabling the user at a receiving display terminal to select types of received electronic mail that do not require authentication.
